(19) United States
(12) Patent Application Publication
(10) Pub. No.: US 2014/0329169 A1
(43) Pub. Date: Nov. 6, 2014

(54) SULFONATED POLYETHERSULFONE COPOLYMER CONTAINING HYDROXYL GROUPS AND PREPARATION METHOD THEREOF, POLYMER ELECTROLYTE MEMBRANE FOR FUEL CELLS AND MEMBRANE ELECTRODE ASSEMBLY COMPRISING THE SAME

(71) Applicant: KOREA INSTITUTE OF SCIENCE AND TECHNOLOGY, Seoul (KR)

(72) Inventors: Hyoung-Juhn KIM, Gyeonggi-do (KR); Yeon Hye KWON, Seoul (KR); Jun Young HAN, Seoul (KR); Hyung Chul HAM, Seoul (KR); Jong Hyun JANG, Seoul (KR); Suk Woo NAM, Seoul (KR); Eun Ae CHO, Seoul (KR); Sung Jong YOO, Seoul (KR); Chang Won YOON, Seoul (KR)

(73) Assignee: KOREA INSTITUTE OF SCIENCE AND TECHNOLOGY, Seoul (KR)

(21) Appl. No.: 14/262,953

(22) Filed: Apr. 28, 2014

(30) Foreign Application Priority Data
May 2, 2013 (KR) 10-2013-0049490

(51) Int. Cl. H01M 8/10

(52) U.S. Cl. CPC H01M 8/1027; H01M 8/1072; H01M 2008/1095; H01M 2300/0082
USPC 429/493; 525/469

(57) ABSTRACT

Provided are a hydroxyl group-containing sulfonated polyethersulfone copolymer, a method for preparing the same, a polymer electrolyte membrane for fuel cell, and a membrane electrode assembly including the same. More particularly, provided are a hydroxyl group-containing sulfonated polyethersulfone electrolyte membrane and a membrane electrode assembly including the same, which are applied to a fuel cell to provide significantly higher ion conductivity as compared to the sulfonated polymer electrolyte membranes according to the related art. The hydroxyl group-containing sulfonated polyethersulfone copolymer electrolyte membrane shows significantly higher ion conductivity under various temperature and humidity conditions as compared to the sulfonated polymer electrolyte membranes according to the related art. Therefore, it is expected that the hydroxyl group-containing sulfonated polyethersulfone copolymer substitutes for expensive fluoropolymer electrolyte membranes such as Nafion.

### CROSS-REFERENCE TO RELATED APPLICATIONS

This application claims priority under 35 U.S.C. §119 to Korean Patent Application No. 10-2013-0049490 filed on May 2, 2013 in the Korean Intellectual Property Office, the disclosure of which is incorporated herein by reference in its entirety.

### TECHNICAL FIELD

The following disclosure relates to a hydroxyl group-containing sulfonated polyethersulfone copolymer, a method for preparing the same, a polymer electrolyte membrane for fuel cell, and a membrane electrode assembly including the same. More particularly, the following disclosure relates to a hydroxyl group-containing sulfonated polyethersulfone electrolyte membrane and a membrane electrode assembly including the same, which are applied to a fuel cell to provide significantly higher ion conductivity as compared to the sulfonated polymer electrolyte membranes according to the related art.

### BACKGROUND

Fuel cells are electrochemical devices by which chemical energy of hydrogen and oxygen contained in a hydrocarbon-based material such as methanol, ethanol or natural gas is converted directly into electric energy. Such an energy conversion process in a fuel cell is highly efficient and eco-friendly, and thus many attentions have been given to fuel cells recently.

In general, fuel cells are classified into phosphoric acid fuel cells (PAFC), molten carbonate fuel cells (MCFC), solid oxide fuel cells (SOFC), polymer electrolyte membrane fuel cells (PEMFC) and alkaline fuel cells (AFC), depending on the type of electrolyte used therein. Although each type of the fuel cells is operated on the basis of the same principle, the types of fuel used in each fuel cell, operation temperatures, catalysts and electrolytes are different from one another. It is known that polymer electrolyte fuel cells among such fuel cells are highly useful not only for transport systems but also for small-scale floor type power generation systems. In this context, a membrane electrode assembly including a polymer electrolyte membrane is a key part of such fuel cells. Thus, active studies have been conducted particularly about polymer electrolyte membranes.

In the case of such polymer electrolyte membranes, fluorine-based electrolyte membranes such as Nafion® available from Dupont Co. have been used currently. However, they are very expensive and show high permeability to hydrogen as fuel and air as oxidant. Thus, development of novel materials has been increasingly in demand (Patent Document 1).

In addition, since perfluorosufonate polymer electrolytes such as Nafion are expensive and have insufficient creep resistance during assemblage or operation, they may cause a drop in voltage or generation of a short circuit, resulting in poor reliability. To solve this problem, some studies have been conducted about the use of a modified fluororesin as a polymer electrolyte membrane. However, this still has a room for improvement in terms of hydrogen and air permeability (Patent Document 2).

Therefore, more recently, as economic hydrocarbon-based polymer electrolyte membranes are developed, active studies have been made to substitute Nafion-based polymers with them. Particularly, hydrocarbon-based polymer electrolyte membranes are advantageous in that they have lower hydrogen and air permeability as compared to fluoropolymer electrolyte membranes. Thus, it is expected that such hydrocarbon-based polymer electrolyte membranes substitute for fluoropolymer electrolyte membranes. Recent studies about hydrocarbon-based polymer electrolyte membranes are focused on sulfonation of aromatic polymers having high mechanical properties in addition to oxidation resistance and stabilities under acidic conditions. Particularly, Haibo Zhang et. al reported that sulfonated poly(arylene ether nitrile ketone) having a cyano (—CN) group introduced to the polymer backbone was prepared and poly(arylene ether nitrile ketone) having a sulfonation degree of 50% and 60% showed high ion conductivity even at high temperature. However, such sulfonated poly(arylene ether nitrile ketone) tends to undergo swelling by absorbing water under a wet condition. In general, in a polymer electrolyte fuel cell, a wet condition and a dry condition are repeated, and the repeated swelling/shrinking may cause cracking in a polymer electrolyte membrane, resulting in degradation of the quality. However, there is no report about the measurement of ion conductivity under various relative humidity conditions (Non-Patent Document 1).

In addition, Baijun Liu et al. reported that sulfonated poly(aryl ether ketone) having a carboxyl group (—COOH) introduced to the polymer backbone was prepared, a crosslinked polymer electrolyte membrane was further prepared through the reaction with polyvinyl alcohol, and the ion conductivity was evaluated as the function of temperature. After the evaluation, it was reported that the crosslinked polymer electrolyte membrane showed an ion conductivity of 0.15 S cm⁻¹ at 65° C., and thus could be applied to direct methanol fuel cells. However, there is no report about the results of measurement of ion conductivity under various relative humidity conditions (Non-Patent Document 2).

Under these circumstances, according to the present disclosure, it has been found that introduction of hydroxyl groups (—OH) capable of forming stronger hydrogen bonds as compared to cyano or carboxyl groups to the aromatic polymer backbone of sulfonated hydrocarbon-based polymer improves ion conductivity significantly, and allows maintenance of high ion conductivity under different temperatures and various relative humidity conditions at a specific sulfonation degree, and thus the sulfonated hydrocarbon-based polymer containing hydroxyl groups can be applied to polymer electrolyte membranes for fuel cells and membrane electrode assemblies including the same. The present disclosure is based on this finding.

### REFERENCES

### Patent Documents

Patent Document 1. U.S. Pat. No. 5,599,638
Patent Document 2. Japanese Patent Laid-Open No. 2002-313364

### Non-Patent Documents

Non-Patent Document 1. Haibo Zhang et al., J. Membr. Sci. 264 (2005) 56-64
Non-Patent Document 2. Baijun Liu et al., J. Mater. Chem., 2008, 18, 4675-4682

### SUMMARY

An embodiment of the present disclosure is directed to providing a hydroxyl group-containing sulfonated polyethersulfone copolymer, which shows significantly higher ion conductivity under various temperature and humidity conditions, as compared to the sulfonated polymer electrolyte membranes according to the related art, as well as providing a method for preparing the hydroxyl group-containing sulfonated polyethersulfone copolymer, and a polymer electrolyte membrane for fuel cells and a membrane electrode assembly using the same

In one general aspect, there is provided a hydroxyl group-containing sulfonated polyethersulfone copolymer having the repeating units represented by the following Chemical Formula 1:

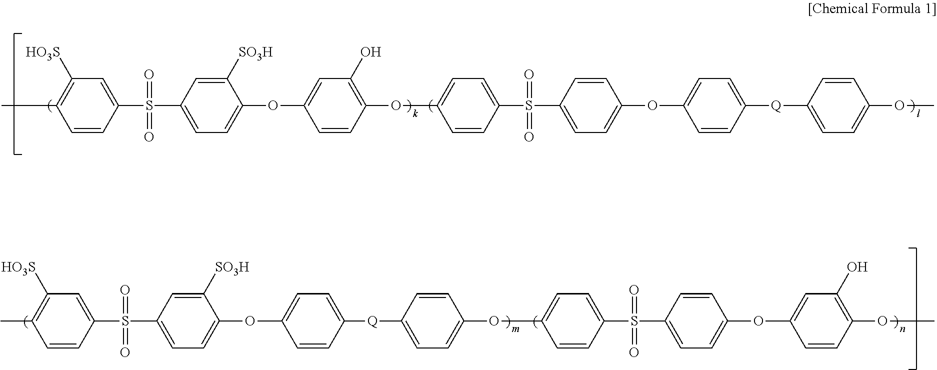

wherein Q is O, S, C(═O), C(═O)NH, Si(CH₃)₂, (CH₂)ₚ (1≦p≦10), (CF₂)_{q} (1≦q≦10), C(CH₃)₂, C(CF₃)₂, or C(CH₃)(CF₃), and each of k, l, m and n corresponds to the molar ratio of each monomer for use in polycondensation.

According to an embodiment, the hydroxyl group-containing sulfonated polyethersulfone copolymer having the repeating units represented by Chemical Formula 1 has a sulfonation degree of 30-70%.

In another general aspect, there is provided a method for preparing a hydroxyl group-containing sulfonated polyethersulfone copolymer, including the steps of:

i) allowing reactants including bis(4-fluoro-3-sulfophenyl)sulfone disodium salt or dipotassium salt, bis(4-fluorophenyl)sulfone, alkoxyhydroquinone, 4,4′-biphenol-based compound and potassium carbonate to react in the presence of a polymerization solvent to obtain sulfonated polyethersulfone copolymer I containing a sodium- or potassium-sulfonate group and alkoxy group;

ii) converting the sodium- or potassium-sulfonate group of the copolymer I into a sulfonyl chloride group to obtain sulfonated polyethersulfone copolymer II containing a sulfonyl chloride group and alkoxy group;

iii) converting the alkoxy group of copolymer II into a hydroxyl group to obtain sulfonated polyethersulfone copolymer III containing a sulfonyl chloride group and hydroxyl group; and

iv) converting the sulfonyl chloride group of copolymer III into a sulfonic acid group.

According to an embodiment, the alkoxyhydroquinone is any one selected from the group consisting of methoxyhydroquinone, ethoxyhydroquinone, n-propoxyhydroquinone, isopropoxyhydroquinone, n-butoxyhydroquinone, isobutoxyhydroquinone, and tert-butoxyhydroquinone.

According to another embodiment, the 4,4′-biphenol-based compound is represented by the following Chemical Formula I:

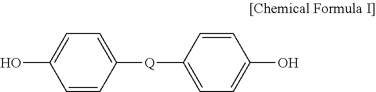

wherein Q is O, S, C(═O), C(═O)NH, Si(CH₃)₂, (CH₂)ₚ (1≦p≦10), (CF₂)_{q} (1≦q≦10), C(CH₃)₂, C(CF₃)₂, or C(CH₃)(CF₃)—.

According to still another embodiment, copolymer I is obtained by mixing the reactants with the polymerization solvent and refluxed at 130-140° C. for 3-4 hours to perform dehydration, and then heating the reaction mixture to 160-180° C. and carrying out reaction for 12-24 hours to obtain a polymer solution, followed by precipitation in isopropyl alcohol, washing with water and drying under vacuum.

According to still another embodiment, the polymerization solvent is a mixture of dimethylacetamide (DMAc) or dimethylsulfoxide (DMSO) with toluene in a volume ratio of 2:1.

According to still another embodiment, the conversion in step ii) is carried out by dissolving copolymer I into dimethylformamide, carrying out reaction with thionyl chloride at 50-60° C. for 3-4 hours, providing a polymer solution from which excess thionyl chloride is removed by distillation, and precipitating the polymer solution in isopropyl alcohol, followed by washing with water and drying under vacuum.

According to still another embodiment, the conversion in step iii) is carried out by dissolving copolymer II into dichloromethane at 0° C. or lower, adding an excessive amount of dealkylating agent gradually thereto under argon atmosphere to carry out reaction of 6-8 hours, and recovering the precipitated product through a filter, followed by washing with water and drying under vacuum.

According to still another embodiment, the dealkylating agent used in the conversion in step iii) is a strong Lewis acid or hydrogen halide.

According to still another embodiment, the strong Lewis acid as dealkylating agent is boron tribromide.

According to yet another embodiment, the conversion in step iv) is carried out by immersing copolymer III into dilute sulfuric acid or hydrochloric acid for 3-4 hours, followed by treatment with boiling water for 12-24 hours and drying.

In still another general aspect, there is provided a polymer electrolyte membrane for fuel cells including the hydroxyl group-containing sulfonated polyethersulfone copolymer.

In still another general aspect, there is provided a method for producing a polymer electrolyte membrane for fuel cells, including the steps of:

i) dissolving sulfonated polyethersulfone copolymer III containing a sulfonyl chloride group and hydroxyl group into dimethyl acetamide, dimethyl sulfoxide or N-methylpyrrolidone to obtain a 2-5 wt % polymer solution;

ii) applying the polymer solution onto a glass plate, followed by drying, to form a membrane; and

iii) immersing the membrane into dilute sulfuric acid or hydrochloric acid solution for 3-4 hours, followed by washing with boiling water, to convert the sulfonyl chloride group into a sulfonic acid group.

In still another general aspect, there is provided a membrane electrode assembly for fuel cells, including the polymer electrolyte membrane for fuel cells disposed between an anode and cathode.

In yet another general aspect, there is provided a fuel cell including the membrane electrode assembly.

The hydroxyl group-containing sulfonated polyethersulfone copolymer disclosed herein shows significantly higher ion conductivity under various temperature and humidity conditions, as compared to the sulfonated polymer electrolyte membranes according to the related art. Therefore, the hydroxyl group-containing sulfonated polyethersulfone copolymer disclosed herein substitutes for expensive fluoropolymer electrolyte membranes such as Nafion, thereby contributing to improvement of the quality of a polymer electrolyte fuel cell.

### BRIEF DESCRIPTION OF THE DRAWINGS

FIG. 1 is ¹H-NMR spectrum of copolymer I obtained from step (i) of Example 1 according to the present disclosure.

FIG. 2 is ¹H-NMR spectrum of the hydroxyl group-containing copolymer obtained from step (iv) of Example 1 according to the present disclosure.

FIG. 3 is FT-IR spectrum (a) of copolymer I obtained from step (i) of Example 1 according to the present disclosure, FT-IR spectrum (b) of copolymer II obtained from step (ii) of Example 1, and FT-IR spectrum (c) of the hydroxyl group-containing copolymer obtained from step (iv) of Example 1.

FIG. 4 to FIG. 6 are graphs illustrating the ion conductivity of each of the polymer electrolyte membranes obtained from Example 2 according to the present disclosure and Comparative Example as the function of temperature and relative humidity.

### DETAILED DESCRIPTION OF EMBODIMENTS

Hereinafter, the hydroxyl group-containing sulfonated polyethersulfone copolymer and the method for preparing the same will be explained in detail. To obtain the target product, hydroxyl group-containing sulfonated polyethersulfone copolymer, a multi-step process is carried out.

In general, to convert the alkoxy group of an aromatic alkoxy group-containing polymer into a hydroxyl group, conversion is to be carried out by using dichloromethane as a solvent. The alkoxy group-containing sulfonated polyethersulfone copolymer obtained from step (i) according to the present disclosure cannot be dissolved in dichloromethane. Thus, it is difficult to carry out the conversion. Therefore, step (ii) is carried out to convert the sodium- or potassium-sulfonate group (—SO₃M, wherein M=Na or K) in the alkoxy group-containing sulfonated polyethersulfone copolymer obtained from step (i) into a sulfonyl chloride group (—SO₂Cl), so that the alkoxy group-containing sulfonated polyethersulfone copolymer may be dissolved in dichloromethane. In this manner, it is possible to obtain a sulfonated polyethersulfone copolymer containing a sulfonyl chloride group and alkoxy group. Then, step (iii) is carried out, wherein the copolymer containing a sulfonyl chloride group and alkoxy group is dissolved into dichloromethane and allowed to react with a dealkylating agent. In this manner, it is possible to obtain a copolymer whose alkoxy group is converted into a hydroxyl group. Herein, particular examples of the dealkylating agent capable of cleaving the ether bond of aromatic alkoxy group to convert the alkoxy group into a hydroxyl group include strong Lewis acids such as boron trichloride (BCl₃) and boron tribromide (BBr₃), or hydrogen halides such as HF, HCl, HBr and HI. Among those, a strong Lewis acid such as boron tribromide is used preferably.

Then, finally, the copolymer obtained from step (iii) is treated with acid and boiling water to convert the sulfonyl chloride group into a sulfonic acid group (—SO₃H), thereby providing the target product, hydroxyl group-containing sulfonated polyethersulfone copolymer according to the present disclosure.

In one aspect, there is provided a hydroxyl group-containing sulfonated polyethersulfone copolymer having the repeating units represented by Chemical Formula 1:

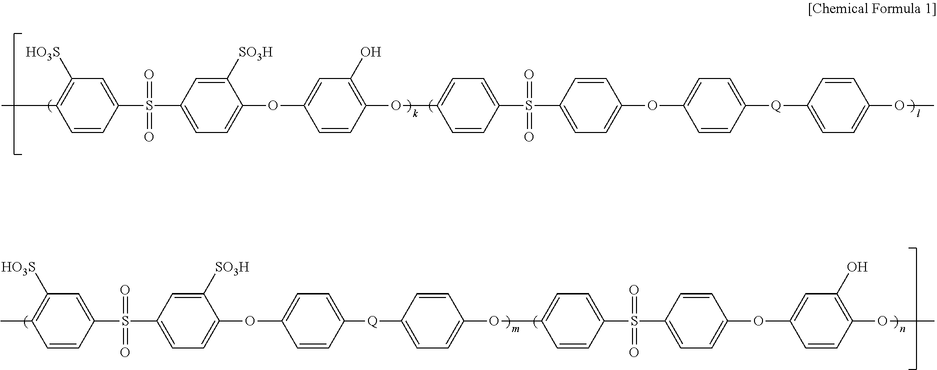

wherein Q is O, S, C(═O), C(═O)NH, Si(CH₃)₂, (CH₂)ₚ (1≦p≦10), (CF₂)_{q} (1≦q≦10), C(CH₃)₂, C(CF₃)₂, or C(CH₃)(CF₃), and each of k, l, m and n corresponds to the molar ratio of each monomer for use in polycondensation.

According to the present disclosure, since the theoretical value of a sulfonation degree is determined by the relative molar ratio of each monomer for use in sulfonation with no accompanying unexpected side reactions, and shows little difference from the analytical value obtained by experiments, it is possible to control a sulfonation degree as necessary by varying the amount of each monomer for use in sulfonation. In other words, as a sulfonation degree increases, a copolymer has increased ion conductivity but shows excessively high hydrophilicity so that it may be swelled or even dissolved in water. On the contrary, as a sulfonation degree decreases, a copolymer shows hydrophobicity and increased resistance against water but has decreased ion conductivity. Thus, it is preferable to control a sulfonation degree adequately in such a manner that a copolymer maintains resistance against water even under high ion conductivity. Therefore, according to an embodiment, a sulfonation degree is controlled within a range of 30-70%. According to a non-limiting embodiment, a preferred sulfonation degree is 30%.

In another aspect, there is provided a method for preparing a hydroxyl group-containing sulfonated polyethersulfone copolymer having the repeating units represented by Chemical Formula 1, including the steps of:

i) allowing reactants including bis(4-fluoro-3-sulfophenyl)sulfone disodium salt or dipotassium salt, bis(4-fluorophenyl)sulfone, alkoxyhydroquinone, 4,4′-biphenol-based compound and potassium carbonate to react in the presence of a polymerization solvent to obtain sulfonated polyethersulfone copolymer I containing a sodium- or potassium-sulfonate group and alkoxy group;

ii) converting the sodium- or potassium-sulfonate group of the copolymer I into a sulfonyl chloride group to obtain sulfonated polyethersulfone copolymer II containing a sulfonyl chloride group and alkoxy group;

iii) converting the alkoxy group of copolymer II into a hydroxyl group to obtain sulfonated polyethersulfone copolymer III containing a sulfonyl chloride group and hydroxyl group; and

iv) converting the sulfonyl chloride group of copolymer III into a sulfonic acid group.

First, in step i), bis(4-fluoro-3-sulfophenyl)sulfone disodium salt or dipotassium salt, bis(4-fluorophenyl)sulfone, alkoxyhydroquinone, 4,4′-biphenol-based compound and potassium carbonate are used as reactants for forming the repeating units of the sulfonated polyethersulfone copolymer. In addition, potassium carbonate (K₂CO₃) that is a weak base is used to form phenolate during the reaction.

The alkoxyhydroquinone used herein is any one selected from the group consisting of methoxyhydroquinone, ethoxyhydroquinone, n-propoxyhydroqu inone, isopropoxyhydroquinone, n-butoxyhydroquinone, isobutoxyhydroquinone, and tert-butoxyhydroquinone. Methoxyhydroquinone is used more preferably in view of reactivity.

In addition, 4,4′-biphenol-based compound represented by Chemical Formula I is used as a monomer:

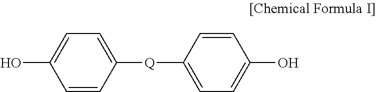

wherein Q is O, S, C(═O), C(═O)NH, Si(CH₃)₂, (CH₂)ₚ (1≦p≦10), (CF₂)_{q} (1≦q≦10), C(CH₃)₂, C(CF₃)₂, or C(CH₃)(CF₃).

The polymerization solvent used in step i) is a mixture of dimethylacetamide (DMAc) or dimethylsulfoxide (DMSO) with toluene in a volumetric ratio of 2:1. Herein, toluene is used in combination with the solvent in order to facilitate removal of water generated as a byproduct during the polycondensation of step i) by using an azeotropic point. The reactants are mixed with the polymerization solvent and dehydrated by refluxing at 130-140° C. for 3-4 hours. Then, the reaction mixture is warmed to 160-180° and subjected to reaction for 12-24 hours to provide a polymer solution, which, in turn, is precipitated in isopropyl alcohol, followed by washing with water and drying under vacuum. In this manner, sulfonated polyethersulfone copolymer I containing a sodium- or potassium-sulfonate group (—SO₃M, M=Na or K) and alkoxy group, represented by Chemical Formula 2, is obtained.

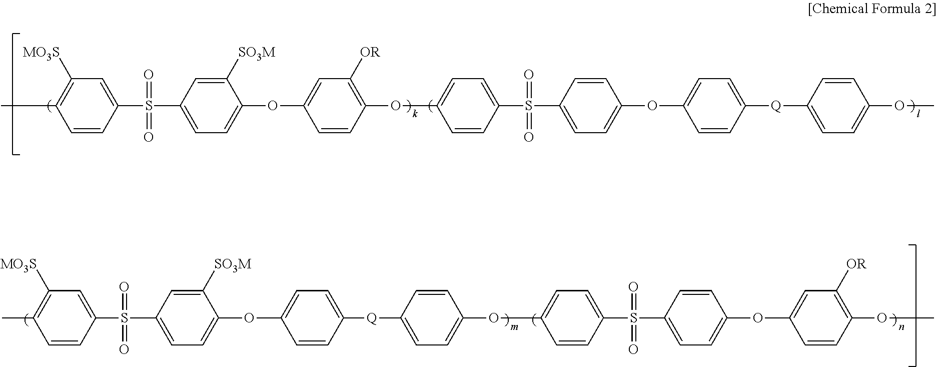

wherein —OR is methoxy group, ethoxy group, n-propoxy group, isopropoxy group, n-butoxy group, isobutoxy group or tert-butoxy group, Q is O, S, C(═O), C(═O)NH, Si(CH₃)₂, (CH₂)ₚ (1≦p≦10), (CF₂)_{q}, (1≦q≦10), C(CH₃)₂, C(CF₃)₂, or C(CH₃)(CF₃), and each of k, l, m and n corresponds to the molar ratio of each monomer for use in polycondensation.

Next, in step ii), the sodium- or potassium-sulfonate group of copolymer I is converted into a sulfonyl group to obtain sulfonated polyethersulfone copolymer II containing a sulfonyl chloride group and alkoxy group. The conversion in step ii) is carried out by dissolving copolymer I into dimethyl formamide (DMF), carrying out reaction with thionyl chloride at 50-60° C. for 3-4 hours to obtain a polymer solution from which excessive thionyl chloride is removed by distillation, and carrying out precipitation of the polymer solution in isopropyl alcohol, followed by washing with water and drying under vacuum, to obtain a sulfonated polyethersulfone copolymer II containing a sulfonyl group and alkoxy group, represented by Chemical Formula 3:

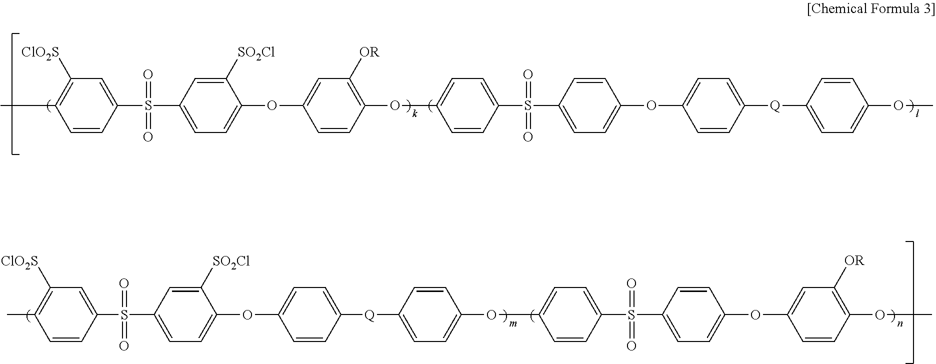

wherein —OR, Q, k, l, m and n are the same as defined in above Chemical Formula 2.

Then, in step iii), the alkoxy group of copolymer II is converted into a hydroxyl group to obtain sulfonated polyethersulfone copolymer III containing a sulfonyl group and hydroxyl group. The conversion in step iii) is carried out by dissolving copolymer II in dichloromethane at 0° C. or lower, adding an excessive amount of dealkylating agent gradually thereto under argon atmosphere to carry out reaction for 6-8 hours, and recovering the precipitated polymer through a filter, followed by washing with water and drying under vacuum, to obtain sulfonated polyethersulfone copolymer III containing a sulfonyl chloride group and hydroxyl group, represented by Chemical Formula 4:

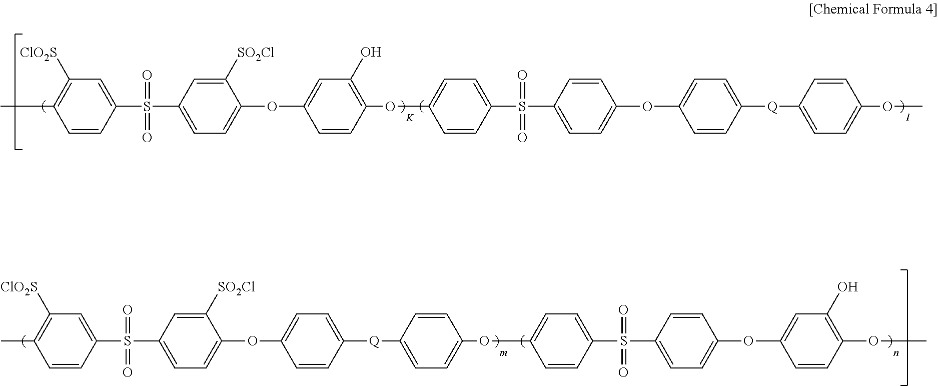

wherein —OR, Q, k, l, m and n are the same as defined in above Chemical Formula 2.

The dealkylating agent used for the conversion in step iii) includes include strong Lewis acids such as boron trichloride (BCl₃) and boron tribromide (BBr₃), or hydrogen halides such as HF, HCl, HBr and HI. Preferably, a strong Lewis acid such as boron tribromide is used.

Finally, in step iv), the sulfonyl group of copolymer III is converted into a sulfonic acid group to obtain the target product, hydroxyl group-containing sulfonated polyethersulfone copolymer represented by Chemical Formula 1. The conversion in step iv) is carried out by immersing copolymer III into dilute sulfuric acid or hydrochloric acid solution for 3-4 hours, and treating the resultant solution with boiling water for 12-24 hours, followed by drying, to obtain the hydroxyl group-containing sulfonated polyethersulfone copolymer represented by Chemical Formula 1.

In addition, basically, the hydroxyl group-containing sulfonated polyethersulfone copolymer represented by Chemical Formula 1 is a hydrocarbon-based aromatic polymer. Further, it has excellent thermal and mechanical properties, lower hydrogen and air permeability as compared to fluoropolymers, and particularly provides improved ion conductivity by virtue of the sulfonation of its polymer backbone, so that it can be used as a polymer electrolyte membrane for fuel cells.

In still another aspect, there is provided a method for producing a polymer electrolyte membrane for fuel cells, including the steps of:

i) dissolving sulfonated polyethersulfone copolymer III containing a sulfonyl chloride group and hydroxyl group into dimethyl acetamide, dimethyl sulfoxide or N-methylpyrrolidone to obtain a 2-5 wt % polymer solution;

ii) applying the polymer solution onto a glass plate, followed by drying, to form a membrane; and

iii) immersing the membrane into dilute sulfuric acid or hydrochloric acid solution for 3-4 hours, followed by washing with boiling water, to convert the sulfonyl chloride group into a sulfonic acid group.

Further, the polymer electrolyte membrane for fuel cells is disposed between an anode and cathode so that it may be applied to a membrane electrode assembly for fuel cells, which, in turn, may be applied as a key part of polymer electrolyte fuel cells.

The examples and experiments will now be described. The following examples and experiments are for illustrative purposes only and not intended to limit the scope of this disclosure.

### Example 1

### Preparation of Hydroxyl Group-Containing Sulfonated Polyethersulfone (Sulfonation Degree 30%)

Step i): Preparation of Sulfonated Polyethersulfone Copolymer I Containing Sodium Sulfonate Group and Methoxy Group

In a 250 mL round-bottom flask, 1.375 g (3 mmol) of bis(4-fluoro-3-sulfophenyl)sulfone disodium salt, 1.780 g (7 mmol) of bis(4-fluorophenyl)sulfone, 0.420 g (3 mmol) of 2-methoxyhydroquinone (3 mmol), 1.598 g (7 mmol) of bisphenol A and 2.764 g (20 mmol) of potassium carbonate are added to a mixture of 10 mL of dimethylacetamide with 5 mL of toluene. A Dean-Stark trap is attached to the flask to carry out dehydration by refluxing at 140° C. for 4 hours. Then, the reaction materials are warmed to 170° C. to carry out reaction for 24 hours, thereby providing a polymer solution. The polymer solution is precipitated in isopropyl alcohol to obtain polymer precipitate, which, in turn, is washed with water several times and dried under vacuum to obtain sulfonated polyethersulfone copolymer I containing a sodium sulfonate group and methoxy group.

Step (ii): Preparation of Sulfonated Polyethersulfone Copolymer II Containing Sulfonyl Chloride Group and Methoxy Group

First, 2.0 g of copolymer I obtained from step (i) is dissolved into 4 mL of dimethyl formamide and 20 mL of thionyl chloride is added thereto to carry out reaction for 4 hours, thereby providing a polymer solution from which excess thionyl chloride is removed by distillation. Next, the polymer solution is precipitated in isopropyl alcohol to obtain polymer precipitate, which, in turn, is washed with water several times and dried under vacuum to obtain sulfonated polyethersulfone copolymer II containing a sulfonyl chloride group and methoxy group.

Step (iii): Preparation of Sulfonated Polyether Suflone Copolymer III Containing Sulfonyl Chloride Group and Hydroxyl Group

First, 2.0 g of copolymer II obtained from step (ii) is dissolved into dichloromethane at 0° C. and an excessive amount of boron tribromide is added gradually thereto under argon atmosphere to carry out reaction for 6 hours. Next, the precipitated polymer is recovered through a filter, washed with water and dried under vacuum to obtain sulfonated polyethersulfone copolymer III containing a sulfonyl chloride group and hydroxyl group.

Step (iv): Conversion of Sulfonyl Group of Copolymer III into Sulfonic Acid Group

First, copolymer III obtained from step (iii) is immersed in 10% hydrochloric acid solution for 3 hours and treated with boiling water for 25 hours, followed by drying, to obtain a hydroxyl group-containing sulfonated polyethersulfone copolymer represented by Chemical Formula 1 (wherein the sulfonyl chloride group of copolymer III is converted into a sulfonic acid group).

### Example 21

### Production of Hydroxyl Group-Containing Polymer Electrolyte Membrane for Fuel Cells

Copolymer III obtained from step (iii) is dissolved into dimethylacetamide to obtain 2 wt % polymer solution. The polymer solution is applied onto a glass plate and dried to form a membrane. The resultant membrane is immersed in 10% hydrochloric acid solution for 3 hours, washed with boiling water to convert the sulfonyl chloride group of copolymer III into a sulfonic acid group, and dried under vacuum to obtain a hydroxyl group-containing polymer electrolyte membrane for fuel cells.

### Comparative Example

### Production of Polymer Electrolyte Membrane for Fuel Cells Containing No Hydroxyl Group

Step (i) is repeated to obtain a sulfonated polyethersulfone copolymer containing a sodium sulfonate group, except that 2-methoxyhydroquinone is not used but 2.283 g (10 mmol) of bisphenol A is used. Then, Example 2 is repeated by using the copolymer obtained as mentioned above to convert the sodium sulfonate group into a sulfonic acid group, thereby providing a polymer electrolyte membrane for fuel cells containing no hydroxyl group.

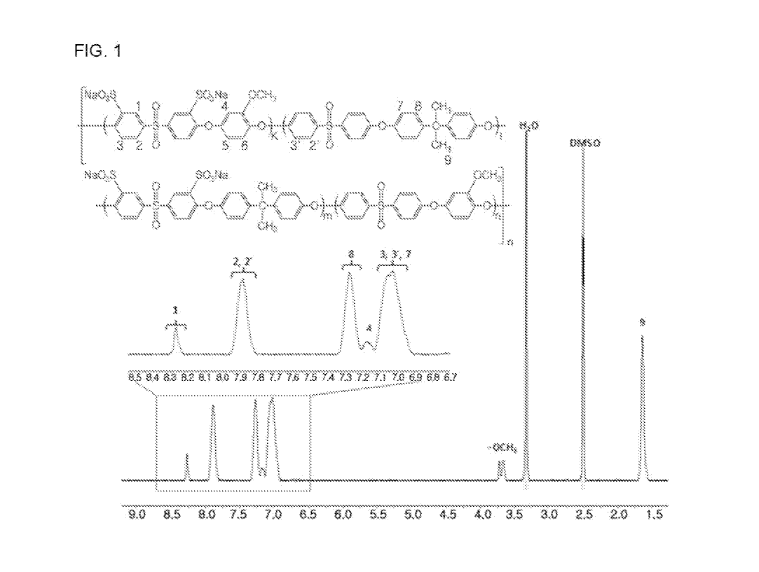

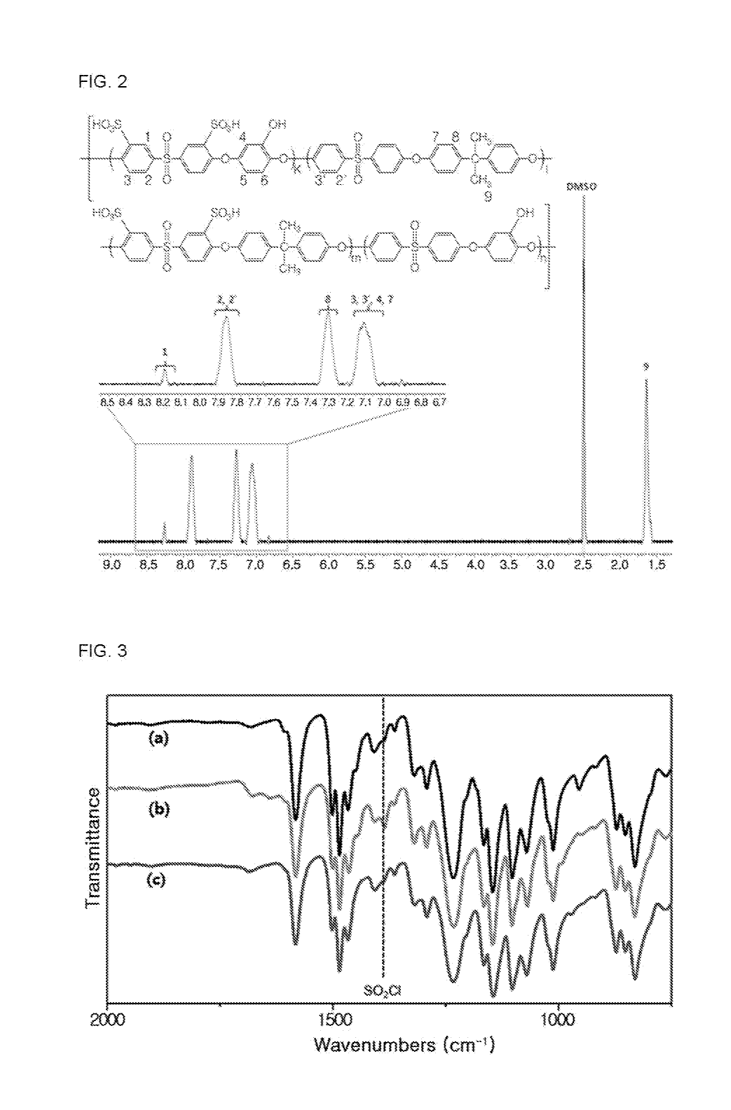

FIG. 1 and FIG. 2 are ¹H-NMR spectra illustrating copolymer I obtained from step (i) of Example 1 and the hydroxyl group-containing copolymer obtained from step (iv) of Example 1, respectively. It can be seen that the hydrogen peak (3.7 ppm) of methoxy group (—OCH₃) occurring in ¹H-NMR spectrum of FIG. 1 disappears completely in ¹H-NMR spectrum of FIG. 2, suggesting that the methoxy group (—OCH₃) is converted into the hydroxyl group (—OH).

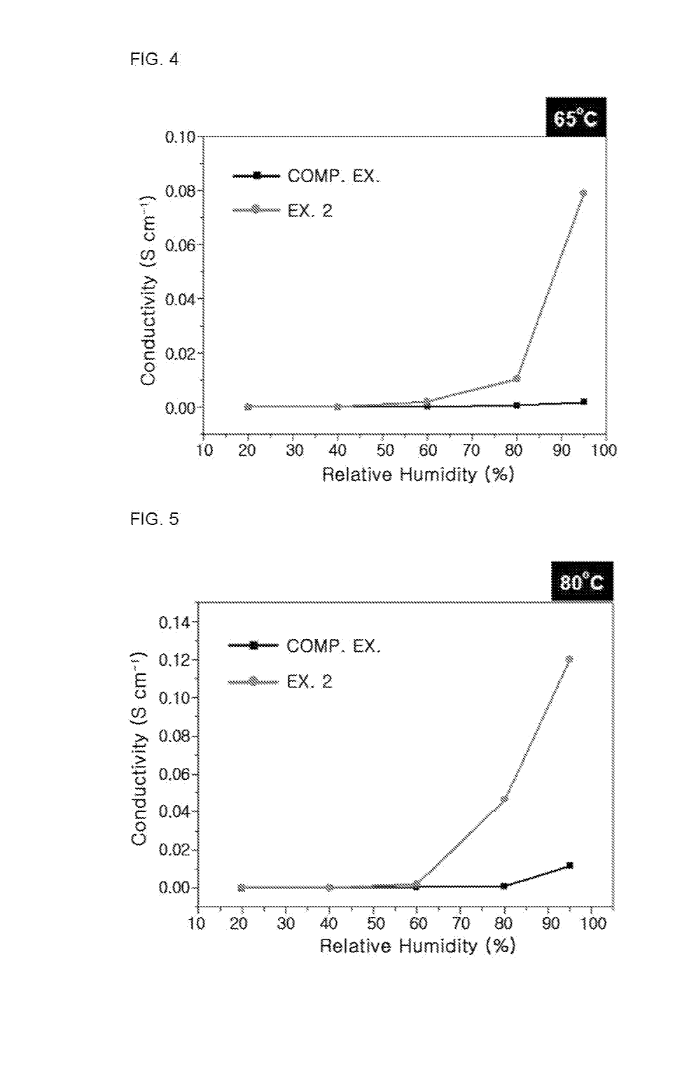

In addition, FIG. 3 is FT-IR spectrum (a) of copolymer I obtained from step (i) of Example 1 according to the present disclosure, FT-IR spectrum (b) of copolymer II obtained from step (ii) of Example 1, and FT-IR spectrum (c) of the hydroxyl group-containing copolymer obtained from step (iv) of Example 1. In portion (b) of FIG. 3, a new absorption peak appears at about 1360-1380 cm⁻¹, suggesting that the sodium sulfonate group of (a) is converted into the sulfonyl chloride group. Further, the absorption peak is not found in (c), suggesting that the sulfonyl chloride group is converted into the sulfonic acid group.

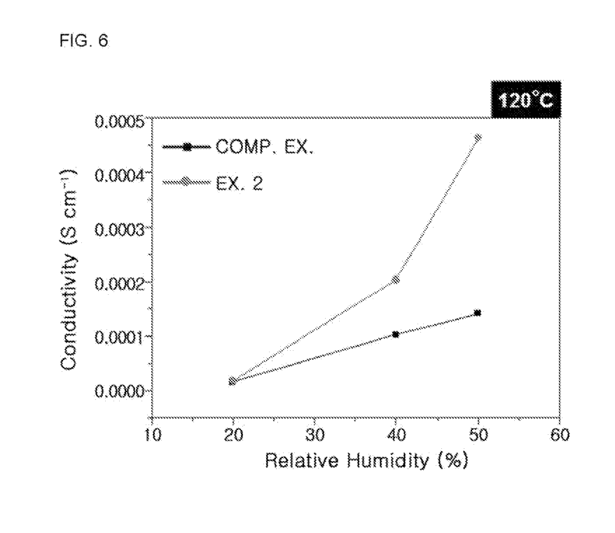

FIG. 4 to FIG. 6 are graphs illustrating the ion conductivity of each of the polymer electrolyte membranes obtained from Example 2 according to the present disclosure and Comparative Example as the function of temperature and relative humidity. As shown in FIG. 4 to FIG. 6, the hydroxyl group-containing polymer electrolyte membrane for fuel cells obtained from Example 2 according to the present disclosure shows improved ion conductivity at substantially all temperature and relative humidity ranges, as compared to the polymer electrolyte membrane for fuel cells containing no hydroxyl group, obtained from Comparative Example. It is thought that the above results are derived from the strong hydrogen bonding of the hydroxyl groups introduced to the polymer backbone in the hydroxyl group-containing sulfonated polyethersulfone copolymer according to the present disclosure.

Therefore, the hydroxyl group-containing sulfonated polyethersulfone copolymer electrolyte membrane according to the present disclosure shows significantly higher ion conductivity under various temperature and humidity conditions as compared to the sulfonated polymer electrolyte membranes according to the related art. Therefore, it is expected that the hydroxyl group-containing sulfonated polyethersulfone copolymer disclosed herein substitutes for expensive fluoropolymer electrolyte membranes such as Nafion, thereby contributing to improvement of the quality of a polymer electrolyte fuel cell. Further, the polymer electrolyte membrane for fuel cells is disposed between an anode and cathode so that it may be applied to a membrane electrode assembly for fuel cells, which, in turn, may be applied as a key part of polymer electrolyte fuel cells.

While the exemplary embodiments have been shown and described, it will be understood by those skilled in the art that various changes in form and details may be made thereto without departing from the spirit and scope of the present disclosure as defined by the appended claims.

What is claimed is:

1. A hydroxyl group-containing sulfonated polyethersulfone copolymer having the repeating units represented by the following Chemical Formula 1: 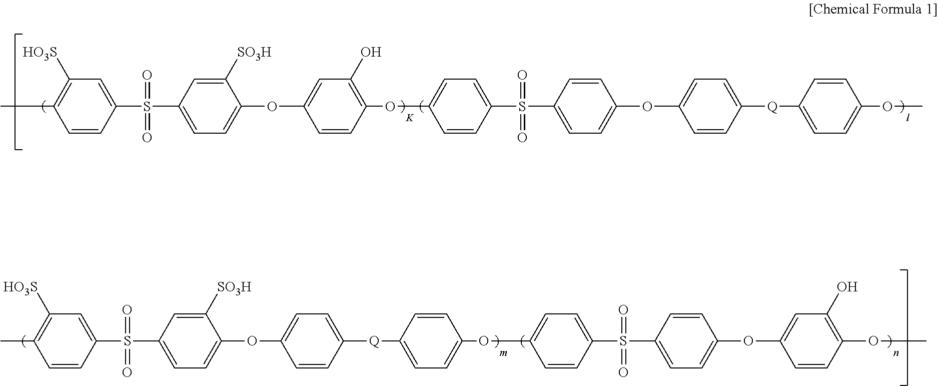
wherein Q is O, S, C(═O), C(═O)NH, Si(CH₃)₂, (CH₂)ₚ (1≦p≦10), (CF₂)_{q} (1≦q≦10), C(CH₃)₂, C(CF₃)₂, or C(CH₃)(CF₃), and each of k, l, m and n corresponds to the molar ratio of each monomer for use in polycondensation.

2. The hydroxyl group-containing sulfonated polyethersulfone copolymer according to claim 1, which has a sulfonation degree of 30-70%.

3. A method for preparing a hydroxyl group-containing sulfonated polyethersulfone copolymer, comprising the steps of:
i) allowing reactants including bis(4-fluoro-3-sulfophenyl)sulfone disodium salt or dipotassium salt, bis(4-fluorophenyl)sulfone, alkoxyhydroquinone, 4,4′-biphenol-based compound and potassium carbonate to react in the presence of a polymerization solvent to obtain sulfonated polyethersulfone copolymer I containing a sodium- or potassium-sulfonate group and alkoxy group;
ii) converting the sodium- or potassium-sulfonate group of the copolymer I into a sulfonyl chloride group to obtain sulfonated polyethersulfone copolymer II containing a sulfonyl chloride group and alkoxy group;
iii) converting the alkoxy group of copolymer II into a hydroxyl group to obtain sulfonated polyethersulfone copolymer III containing a sulfonyl chloride group and hydroxyl group; and
iv) converting the sulfonyl chloride group of copolymer III into a sulfonic acid group.

4. The method for preparing a hydroxyl group-containing sulfonated polyethersulfone copolymer according to claim 3, wherein the alkoxyhydroquinone is any one selected from the group consisting of methoxyhydroquinone, ethoxyhydroquinone, n-propoxyhydroquinone, isopropoxyhydroquinone, n-butoxyhydroquinone, isobutoxyhydroquinone, and tert-butoxyhydroquinone.

5. The method for preparing a hydroxyl group-containing sulfonated polyethersulfone copolymer according to claim 3, wherein the 4,4′-biphenol-based compound is represented by the following Chemical Formula I: 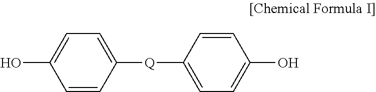
wherein Q is O, S, C(═O), C(═O)NH, Si(CH₃)₂, (CH₂)ₚ (1≦p≦10), (CF₂)_{q} (1≦q≦10), C(CH₃)₂, C(CF₃)₂, or C(CH₃)(CF₃).

6. The method for preparing a hydroxyl group-containing sulfonated polyethersulfone copolymer according to claim 3, wherein copolymer I of step (i) is obtained by mixing the reactants with the polymerization solvent and refluxed at 130-140° C. for 3-4 hours to perform dehydration, and then heating the reaction mixture to 160-180° C. and carrying out reaction for 12-24 hours to obtain a polymer solution, followed by precipitation in isopropyl alcohol, washing with water and drying under vacuum.

7. The method for preparing a hydroxyl group-containing sulfonated polyethersulfone copolymer according to claim 6, wherein the polymerization solvent is a mixture of dimethylacetamide (DMAc) or dimethylsulfoxide (DMSO) with toluene in a volume ratio of 2:1.

8. The method for preparing a hydroxyl group-containing sulfonated polyethersulfone copolymer according to claim 3, wherein the conversion in step ii) is carried out by dissolving copolymer I into dimethylformamide, carrying out reaction with thionyl chloride at 50-60° C. for 3-4 hours, providing a polymer solution from which excess thionyl chloride is removed by distillation, and precipitating the polymer solution in isopropyl alcohol, followed by washing with water and drying under vacuum.

9. The method for preparing a hydroxyl group-containing sulfonated polyethersulfone copolymer according to claim 3, wherein the conversion in step iii) is carried out by dissolving copolymer II into dichloromethane at 0° C. or lower, adding an excessive amount of dealkylating agent gradually thereto under argon atmosphere to carry out reaction of 6-8 hours, and recovering the precipitated product through a filter, followed by washing with water and drying under vacuum.

10. The method for preparing a hydroxyl group-containing sulfonated polyethersulfone copolymer according to claim 9, wherein the dealkylating agent used in the conversion in step iii) is a strong Lewis acid or hydrogen halide.

11. The method for preparing a hydroxyl group-containing sulfonated polyethersulfone copolymer according to claim 10, wherein the strong Lewis acid as dealkylating agent is boron tribromide.

12. The method for preparing a hydroxyl group-containing sulfonated polyethersulfone copolymer according to claim 3, wherein the conversion in step iv) is carried out by immersing copolymer III into dilute sulfuric acid or hydrochloric acid for 3-4 hours, followed by treatment with boiling water for 12-24 hours and drying.

13. A polymer electrolyte membrane for fuel cells comprising the hydroxyl group-containing sulfonated polyethersulfone copolymer as defined in claim 1.

14. A method for producing a polymer electrolyte membrane for fuel cells, comprising the steps of:
i) dissolving copolymer III as defined in claim 3 into dimethyl acetamide, dimethyl sulfoxide or N-methylpyrrolidone to obtain a 2-5 wt % polymer solution;
ii) applying the polymer solution onto a glass plate, followed by drying, to form a membrane; and
iii) immersing the membrane into dilute sulfuric acid or hydrochloric acid solution for 3-4 hours, followed by washing with boiling water.

15. A membrane electrode assembly for fuel cells, wherein the polymer electrolyte membrane for fuel cells as defined in claim 13 is disposed between an anode and cathode.

16. A fuel cell comprising the membrane electrode assembly as defined in claim 15.
